(19) United States
(12) Patent Application Publication
(10) Pub. No.: US 2022/0355350 A1
(43) Pub. Date: Nov. 10, 2022

(54) MICRO-/NANO-STRUCTURED ANTI-BIOFILM SURFACES

(71) Applicant: THE UNIVERSITY OF HONG KONG, Hong Kong (HK)

(72) Inventors: Gary Shun Pan Cheung, Sai Ying Pun (HK); James Kit Hon Tsoi, Sai Ying Pun (HK); Xin Li, Sai Ying Pun (HK); Zhiyong Fan, Hong Kong (HK); Hoi Kwong Tsui, Hong Kong (HK)

(21) Appl. No.: 17/619,044

(22) PCT Filed: Apr. 14, 2020
(86) PCT No.: PCT/CN2020/084693

§ 371 Date: Dec. 14, 2021

Related U.S. Application Data
(60) Provisional application No. 62/833,871, filed on Apr. 15, 2019.

(51) Int. Cl. B08B 17/06; A61C 8/00

(52) U.S. Cl. CPC B08B 17/065; A61C 8/0037; A61C 2008/0046; B82Y 30/00

(57) ABSTRACT

Disclosed is a low-cost, scalable and highly repeatable approach to fabricate polystyrene films with three-dimensional nanopyramids on the surface. The nanopyramids have tubable aspect ratio and anti-bacterial performance. The effectiveness of the nanopyramids on bacterial and fungi growth inhibition and the role of nanostructure aspect ratio are confirmed via through scanning electron microscopy and confocal laser scanning microscopy. The results show an excellent antibacterial performance with more than 90% reduction in E. coli population in all nanopyramid samples after a 168-hr prolonged incubation time. The nanopyramid film developed here can be used for the clinical and commercial applications to prevent the growth of pathogenic bacteria on various surfaces.

### TECHNICAL FIELD

Disclosed are micro-/nano-structured anti-biofilm surfaces, methods of making anti-biofilm surfaces, methods of reducing bacterial and fungal growth, and dental appliances having micro-/nano-structured anti-biofilm surfaces.

### BACKGROUND

Pathogenic bacteria has long been and continues to be a threat to public health as it may cause morbidity and mortality. In recent years, the prevalence of multidrug-resistant bacteria has become a serious challenge in the clinical area. The trace of multidrug-resistant bacteria contamination can be easily found on inanimate surfaces and equipment in the intensive care unit (ICU) and surgery ward. In fact, medical equipment and high-contact communal surfaces such as a computer keyboard, curtains, entry doors and floors are the incubation sites for pathogenic biofilm formation. Both Gram-positive and Gram-negative bacteria can remain alive for months under humid and low temperature conditions.

Moreover, cross-transmission of bacteria from inanimate surfaces may play a significant role for ICU-acquired colonization and infections. Traditionally, chemical-based disinfection is used to remove the bacteria on various surfaces. However, regular cleaning with chlorine solution may not completely remove the multidrug-resistant bacteria containing a biofilm on dry surfaces. Furthermore, the chemical residue from the cleaning may be harmful to patients and the effectiveness does not last for a long period of time. Nanomaterials such as silver nanoparticles, silicon nanowires or carbon nanotubes have been proposed for antibacterial and biomedical applications, but the toxicity of these nanomaterials is a concern requiring further evaluation.

Recently, mechanobiological influence of micro/nanostructures on cells and bacteria has attracted much attention. Nanostructured surfaces have been proven effective to inhibit the bacteria growth on surfaces. The main mechanism is based on a biophysical bactericide model in which bacteria are neutralized by the mechanical puncturing and rupturing without using any chemical agent. Disinfectant-free bactericidal processes are favorable for clinical applications because they can reduce the risk of chemical residue contamination. However, most of the potential bactericidal nanostructures are fabricated on solid substrates such as silicon, titanium and aluminum because of the advances in photovoltaic devices in the past decades.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

One aspect of the invention relates to a dental appliance having antimicrobial properties, the dental device comprising nanostructures on at least a portion of a surface thereof, the nanostructures having a pyramid-like shape with a periodicity from to 0.25 μm to 5 μm, a height from 0.25 μm to 5 μm, and an aspect ratio from 0.5 to 5.

Another aspect of the invention relates to a method of inhibiting the formation of a biofilm on a medical device involving applying nanostructures on at least a portion of a surface of the medical device, the nanostructures having a pyramid-like shape with a periodicity from to 0.25 μm to 5 μm, a height from 0.25 μm to 5 μm, and an aspect ratio from 0.5 to 5.

Yet another aspect of the invention relates to a method of inhibiting the formation of a biofilm on a dental appliance involving applying nanostructures on at least a portion of a surface of the medical device, the nanostructures having a pyramid-like shape with a periodicity from to 0.25 μm to 5 μm, a height from 0.25 μm to 5 μm, and an aspect ratio from 0.5 to 5.

Still yet another aspect of the invention relates to a method of inhibiting the growth of bacteria and/or fungi on a dental appliance involving applying nanostructures on at least a portion of a surface of the medical device, the nanostructures having a pyramid-like shape with a periodicity from to 0.25 μm to 5 μm, a height from 0.25 μm to 5 μm, and an aspect ratio from 0.5 to 5.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 depicts schematics of nanopyramid fabrication process and SEM images of inverted pyramid templates: a) A <100> oriented Si wafer with 100 nm SiO₂ undergone photolithography with 1.5 μm square array pattern and BOA etching, b) The patterned wafer undergone TMAH etching to form i-pyramid template, c) Different thickness of chromium sputtered on the surface, d) Regular nanopyramid on PS film after peeling off, e) 400 nm chromium sputtered template, f) 800 nm chromium sputtered template, and g) 1200 nm chromium sputtered template.

FIG. 2 depicts a) Flexible PS nanopyramid film, SEM image of b) NPA PS film, c) NPB PS film, d) NPC PS film, water contact angle of e) Planar PS film, f) NPA PS film, g) NPB PS film, and h) NPC PS film.

FIG. 3 shows SEM images of bacteria interaction with different samples for a-d) 1-hour incubation time, e-h) 24-hour incubation time, i-l) 72-hour incubation time, and m-p) 168-hour incubation time. Scale bar: 1 μm.

FIG. 4 shows CLSM images of live (green) and dead (red) fluorophore-tagged E. coli on the surface of different samples for 1-hour (a-d), 24-hour (e-h), 72-hour (i-l), and 168-h (m-p) incubation time (per 200×200 μm2). Scale bar: 10 μm.

FIG. 5 graphically depicts a summary of CLSM result of different samples for different cell incubation time: a) Live E. coli colonization, b) Dead E. coli colonization, c) Percentage of live E. coli occupied in total number of adhered E. coli, and d) Antibacterial efficiency of different nano-patterned samples against living E. coli compared to planar sample.

FIG. 6 shows Equation 1.

FIG. 7 depicts Table 51 providing an information summary of CLSM result: a) Summary of Live E. coli, and b) Summary of Dead E. coli.

FIG. 8 shows a scanning electron microscope (SEM) images of different i-pyramid molds with different thickness of sputtered Cr. Scanning electron micrographs of (a) C1, (b) C2 and (c) C3 inversed pyramid surfaces. (Scale bar=1 μm).

FIG. 9 shows Table 1.

FIG. 10 shows photographs of the Cr-sputtered i-pyramid molds and fabricated nano-pyramid PMMA films: (a) Flat silica wafer, (b) flat PMMA film, (c) C1 mold, (d) N1 film, (e) C2 mold, (f) N2 film, (g) C3 mold, and (h) N3 film.

FIG. 11 SEM micrographs showing the surface topographies produced for different PMMA surfaces: (a) N1, (b) N2, (c) N3, and (d) Smooth control. (Scale bar=1 μm, magnification: ×10,000).

FIG. 12 shows Table 2.

FIG. 13 The three-dimensional (3D) projections of typical AFM images and the average of roughness (Ra) values: Surface profiles of (a) the smooth control, (b) NP400, (c) NP800, (d) NP1200, and (e) Ra values, error bars: 95% CI. (*p<0.05, all 3 experimental groups were statistically different from the control).

FIG. 14 shows Table 3: the static water contact angle (WCA) and surface free energy (SFE) of different PMMA surfaces.

FIG. 15 shows confocal scanning laser microscopy (CLSM) images of Candida albicans biofilm grown on the different PMMA surfaces at the different incubation time period: (a-d) 1-hour incubation; (e-h) 1-day incubation; (i-l) 2 day incubation; (m-p) 3-day incubation (measurement area=126×126 μm2, image size=640×640 pixels). (Scale bar=10 μm).

FIG. 16 shows the SEM images of C. albicans on the different PMMA surfaces at 1 hour: (a) Smooth control; (b) N1; (c) N2; and (d) N3. (Scale bar=1 μm, magnification: ×10,000).

FIG. 17 shows the SEM images of C. albicans on the different PMMA surfaces at 1 day: (a) Smooth control; (b) N1; (c) N2; and (d) N3. (Scale bar=1 μm, magnification: ×10,000).

FIG. 18 shows the SEM images of C. albicans on the different PMMA surfaces at 2 days: (a) Smooth control; (b) N1; (c) N2; and (d) N3. (Scale bar=1 μm, magnification: ×10,000).

FIG. 19 shows the SEM images of C. albicans on the different PMMA surfaces at 3 days: (a) Smooth control; (b) N1; (c) N2; and (d) N3. (Scale bar=1 μm, magnification: ×10,000).

### DETAILED DESCRIPTION

It has been found that is difficult to apply bactericidal and/or fungicidal nanostructures to existing inanimate surfaces and equipment. In this regard, polymeric nanostructured films are promising alternative because the films can be readily attached to any surface as protection films of window. However, current reports on using polymer nanostructures for bactericide are limited by the small size of the nanostructured film, primarily fabricated with a biotemplating method, in which the polymeric nanostructured surfaces are obtained from the replicating the nanostructures from biospecies bodies, such as gecko skin. The small size of the animal's body surface limits the size of the replicated film. Furthermore, the variations on nanostructure geometry in the biospecies bodies hinder the development of large-scale process because of the high-cost for body sampling and complicated replication process.

In this disclosure, described herein is a facile molding process to fabricate flexible polystyrene (PS) antibacterial films with three-dimensional (3D) nanopyramid arrays on a surface. The geometry of the nanopyramid, i.e., their aspect ratio and pitch, can be precisely controlled by tuning the structure of the inverse nanopyramid template in the herein described fabrication process. The antibacterial film can be easily attached to any surface, such as curtains, walls in clinical wards, medical instruments, medical appliances, etc., to prevent the pathogenic bacteria from forming biofilm.

The fabrication method can be further developed into production scale process and the low cost feature of polystyrene enables large scale utilization in clinical applications. Particularly, the antibacterial effectiveness on Gram-negative bacterium Escherichia coli (E. coli) has been evaluated using scanning electron microscope (SEM) and confocal laser scanning microscope (CLSM). In this context, more than 90% reduction of E. coli colonization has been identified. The effectiveness can be maintained up to 168 hours without cleaning.

Furthermore, by tuning the aspect ratio of inverse nanopyramid nanostructures, systematic investigation of nanopyramid geometry on bacteriacidal performance has been performed. It has been found that the sharper pyramid surface has a better antibacterial effect in the initial stage, but the prolonged antibacterial effect is not as effective as less sharp nanopyramid surface. This disclosure helps to describe the mechanism of biophysical bactericidal effect with nanostructures.

The nanostructures have a pyramid-like shape that contributes to the antimicrobial properties. In this context, pyramid-like shape means that that the top portion is always narrower than the bottom portion of the structure. Examples of pyramid-like shapes not only include three sided pyramids, four sided pyramids, five sided pyramids, six sided pyramids, and so on, but also thorn-like shapes, spinule-like shapes, cone-shapes, and the like. The pyramid-like shape can be symmetrical or asymmetrical.

The nanostructures have a periodicity that contributes to the antimicrobial properties. In one embodiment, the nanostructures have a periodicity from to 0.25 μm to 5 μm. In another embodiment, the nanostructures have a periodicity from to 0.5 μm to 4 μm. In yet another embodiment, the nanostructures have a periodicity from to 1 μm to 3 μm.

The nanostructures have a spacing that contributes to the antimicrobial properties (that is, the distance from the base of one nanostructure to the base of an adjacent nanostructure). In one embodiment, the nanostructures have a spacing 100 nm to 5,000 nm. In another embodiment, the nanostructures have a spacing 200 nm to 4,000 nm. In yet another embodiment, the nanostructures have a spacing 300 nm to 2,500 nm.

The nanostructures have a height that contributes to the antimicrobial properties. In one embodiment, the nanostructures have a height from 0.25 μm to 5 μm. In another embodiment, the nanostructures have a height from 0.5 μm to 4 μm. In yet another embodiment, the nanostructures have a height from 1 μm to 3 μm.

The nanostructures have a bottom width that contributes to the antimicrobial properties. In one embodiment, the nanostructures have a bottom width from 250 nm to 5,000 nm. In another embodiment, the nanostructures have a bottom width from 500 nm to 4,000 nm. In yet another embodiment, the nanostructures have a bottom width from 750 nm to 2,500 nm. It is noted that the top portion is always narrower than the bottom portion of the pyramid-like nanostructures.

The nanostructures have an aspect ratio that contributes to the antimicrobial properties. In one embodiment, the nanostructures have an aspect ratio from 0.5 to 5. In another embodiment, the nanostructures have an aspect ratio from 0.75 to 4. In yet another embodiment, the nanostructures have an aspect ratio from 1 to 3.

It is noted that the molds for making the nanostructures have the same structure, periodicity, spacing, height, bottom width, and aspect ratio as the nanostructures as described above.

Antimicrobial properties encompass the ability to kill microbes and/or inhibit the growth/reproduction/spread of microbes and/or reduce the growth/reproduction/spread of microbes. Microbes include bacteria and fungi, such as yeasts. Non-limiting examples of fungi genera include Candida, Cladosporium, Aureobasidium, Saccharomycetales, Aspergillus, Fusarium, and Cryptococcus. Non-limiting examples of fungi include Candida albicans, Candida parapsilosis, Candida tropicalis, Candida glabrata, Candida krusei, Candida guilliermondii, and Candida lusitaniae, Histoplasma capsulatum, Cryptococcus neoformans, Cryptococcus gattii, Aspergillus fumigatus, Coccidioides immitis, and Coccidioides posadasii. Non-limiting examples of bacteria genera include Actinomyces, Arachnia, Bacteroides, Bifidobacterium, Eubacterium, Fusobacterium, Gemella, Granulicatella, Lactobacillus, Leptotrichia, Peptococcus, Peptostreptococcus, Propionibacterium, Selenomonas, Streptococcus, Treponema, and Veillonella. Non-limiting examples of bacteria include Escherichia coli, Actinobacillus actinomycetemcomitans, Streptococcus salivarius, Streptococcus mutans, and Streptococcus sanguinis.

Described herein is an effective way to keep the surface of dental appliances clean, to inhibit attachment of microorganisms and physically kill those that manage to attach to the material surface without the need for chemical agents. This application is highly valuable especially for those aged individuals who are denture-wearers and have reduced manual dexterity to maintain an excellent oral hygiene, as it aims to overcome the limitations (namely, lack of anti-biofilm property) of existing appliances made of the un-modified material.

The subject matter herein imparts an anti-biofilm activity to a common polymeric dental material that is used for making dentures. This anti-biofilm and antifungal property are very useful for prevention of denture-induced stomatitis, which condition is caused or aggravated by microorganisms, especially fungi. More specifically, dental compositions described herein are useful for preparing dental appliances and articles that repel or inactivate one or more microbes (especially fungi/yeast) in the oral environment.

The application of biomimetic nanostructures on the dental devices, such as prostheses, is considered as an alternative and effective way to inhibit biofilm formation through mechanical penetration and physical shredding of adherent bacteria on their surfaces. No chemical agent is needed to maintain an excellent antibacterial effect for an extended period time.

Described herein is a relatively simple method of incorporating antimicrobial properties into dental prostheses, without the need to use chemical agents. The nano-textured surface is easy to maintain and keep clean.

The nano-textured surface is highly valuable to the dental clinical applications, especially for dental rehabilitation devices and appliances. As the population of the aged increases, there is a growing demand on high quality dental appliances such as removable partial and complete dentures. Despite the sophistication in design and advances in material science, polymeric dental appliances remain as one of the mainstream solutions to replace missing teeth and oral structures, to restore function and appearance for patients. However, these appliances are not immune from the formation of bacteria-laden biofilm on their surfaces. Patients may then suffer from mucosal diseases due to the aggregation of biofilm on the surface of the protheses. Currently, antibiotics or chemical antimicrobial agents are used to manage the mucosal condition or to prevent bacterial growth on the prostheses, but such practice may lead to more serious health problems such as antibiotic resistance and body side effects. The application of biomimetic surface nanostructures as described herein is considered as an effective way to inhibit biofilm formation; as no chemical agent is needed.

Described herein are anti-bacterial, nano-structural surfaces especially suitable for dental clinical applications, among other medical applications. The surfaces can maintain an excellent antibacterial effect and that antimicrobial activity can be refreshed by a simple procedure. Dental prostheses with such nano-textured surfaces can benefit many elderly individuals who may be lacking the necessary manual dexterity to maintain the cleanliness of the dental appliances in time.

Described herein are the optimal nanostructures that can effectively inhibit the growth of biofilm for dental clinical applications. On one hand, the surfaces can be readily applied to common dental polymeric materials (polymethyl methacrylate, in particular) and, hence, be used in clinical application as described above. On another hand, the methods herein can apply the principle to identify appropriate dental materials including plastics and metals which are suitable for building nanostructured, biocompatible and anti-bacterial surfaces on top.

Common dental devices that are made of polymethyl methacrylate, such as complete or partial dentures, and removable orthodontic retainers, but other materials can be used. Also described herein is the application to restorative resin composite material and dental implants with micro-/nano-structures, for a lasting anti-biofilm property to enhance the longevity of these treatment modalities.

The micro-/nano-structures can be fabricated on different dental materials with a flat surface. Nevertheless, the majority of dental prostheses can have undulated or curved surfaces, and the micro-/nano-structures can be fabricated thereon as well.

The following examples illustrate the subject invention. Unless otherwise indicated in the following examples and elsewhere in the specification and claims, all parts and percentages are by weight, all temperatures are in degrees Centigrade, and pressure is at or near atmospheric pressure.

Fabrication of i-Pyramid Template with Different Aspect Ratio

A clean <100> oriented Si wafer with 100 nm thermally grown silicon oxide on the surface was spin-coated with a photoresist AZ7908 and patterned with photolithography to obtain a regular square array of pits with a pitch of 1.5 μm.

Then, the patterned wafer was etched with benzoxazolinone (BOA) to remove the exposed Si oxide layer, which functions as an etching mask in the subsequent i-pyramid formation. After removing the photoresist in acetone, the wafer was then put into the 15% tetramethylammonium hydroxide (TMAH) solution at 50° C. for 50 mins. The highly regular array of inverted pyramids (i-pyramids) was formed by anisotropic etching of the patterned Si wafer. Finally, 400 nm, 800 nm or 1200 nm of chromium were sputtered to wafers respectively to adjust the aspect ratio of the i-pyramids using Nano-master NSC3000 Sputtering System (SPT-NSC3000).

Fabrication of Nanopyramid Films

Polystyrene (PS) with average molecular weight of around 192,000 was purchased from Sigma Aldrich. The material (10 g) was dissolved in 100 mL of toluene to obtain a PS solution. Then, the solution was poured onto the i-pyramid wafer. The PS solution was first heat cured at 90° C. for 3 hours and then was held at 120° C. for the next 30 mins. After that, the PS nanopyramid film was readily peeled off from the i-pyramid wafer, owing to the anti-sticking property of chromium. Groups of specimens, Nanopyramid type A (NPA), Nanopyramid type B (NPB) and Nanopyramid type C (NPC), are obtained corresponding to the nanopyramid films obtained from templates coated with 400 nm, 800 nm or 1200 nm of chromium respectively.

Characterization and Bacterial Cell Viability Analysis

SEM images were taken by a JEOL JSM-7100F SEM operated at 10 kV. Water contact angle was measured using USA KINO contact angle meter SL200 KB with water droplet volume of 5 μL. For the bacterial cell viability analysis, confocal laser scanning microscopy (CLSM) was taken to visualize the relative proportion of live and dead cells on the nanopyramid surface after staining with the LIVE/DEAD BacLight Bacterial Viability Kit (L-7012 Invitrogen, Molecular Probes, Eugene, Oreg., USA) according to the manufacturer's protocol. This proprietary staining kit contains a mixture of SYTO 9 and propidium iodide fluorescent dyes that make live bacteria show up in green and dead bacteria in red color. Nine randomly assigned regions of each specimen with field measured 200 μm×200 μm were imaged using a CLSM (IX81 FluoView FV1000, Olympus, Tokyo, Japan). All CLSM images were imported into the computer and the amount of live and dead bacterial cells on the surfaces were determined using the image analysis software (ImageJ, National Institute of Health, Bethesda, Md., USA).

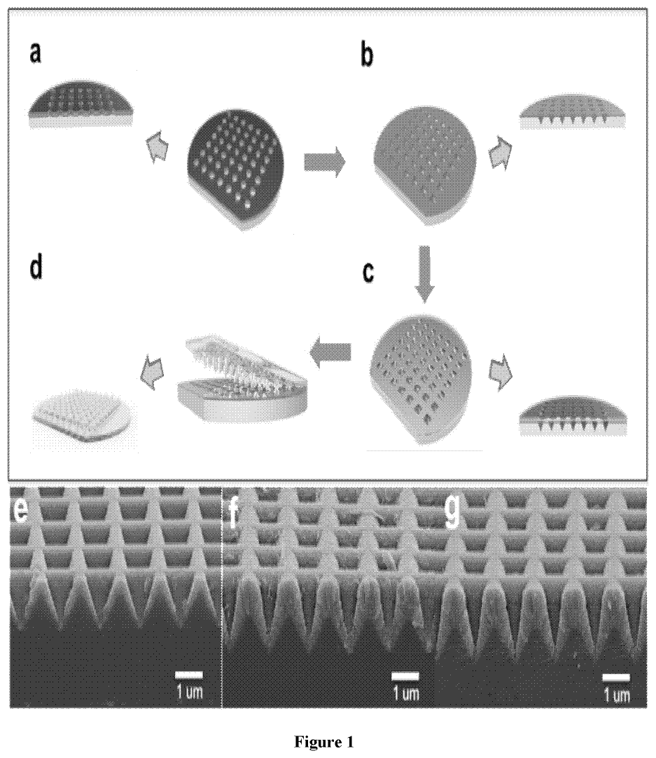

Referring to FIG. 1, the inverted nanopyramid arrays were fabricated on <100> oriented silicon (Si) substrate with the aspect ratio of the i-pyramids adjusted by depositing different thickness of Cr in position, as mentioned in the Experimental Section. This chromium-sputtered array becomes the negative template for molding with polystyrene (PS) solution to obtain flexible nanopyramid films. Note that PS is a low cost, widely used plastics in our daily life. It is commonly used in the form of containers in clinical applications. On the other hand, other plastic materials, such as PMMA, polycarbonate, etc., can also be molded with the similar approach, allowing a wide choice of material to satisfy various practical requirements in clinical applications. FIGS. 1a-d showed the schematics of the i-pyramid template fabrication process. The detailed fabrication process is shown the Experimental Section. Dimension of the i-pyramid were controlled by the etching time, however they all have a fixed aspect ratio (Ratio of Height to width) of 1.41 because of unique anisotropic etching property of Si. In order to modulate the aspect ratio of i-pyramid, 400 nm, 800 nm and 1200 nm of chromium were sputtered to wafers (see FIG. 1e-g). The i-pyramid became sharper with thicker Cr deposition. And the aspect ratio of i-pyramids also increased when thicker Cr was deposited. This is a unique approach to precisely modulate the aspect ratio of a regular array of i-pyramid in nanoscale. To prepare the films (FIG. 1d), PS solution was poured on the surface of the templates. A transparent PS film with regular, positive, protruding nanopyramids on its surface was obtained after directly peeling it off from the Si mold. The 3 groups of PS films, Nanopyramid type A (NPA), Nanopyramid type B (NPB) and Nanopyramid type C (NPC) represent the nanopyramid films replicated from 400 nm, 800 nm and 1200 nm chromium sputtered template respectively. A planar, microscopically smooth PS film was fabricated by molding a polished, flat Si wafer as the control sample to compare the result with nanopyramids. It is worth noting that the Cr layer also served very well as an anti-adhesive layer. This means that the template could be reused for multiple times without any residual PS material left on its surface. Furthermore, multiple templates can be stitched together to an even larger template for the process. Compared to other reported approaches, such as casting and molding from gecko skin or cicada wing, the fabrication process described here is much more controllable and the nanostructured films have much better uniform. Potentially, large-scale and practical films can be easily fabricated using this method.

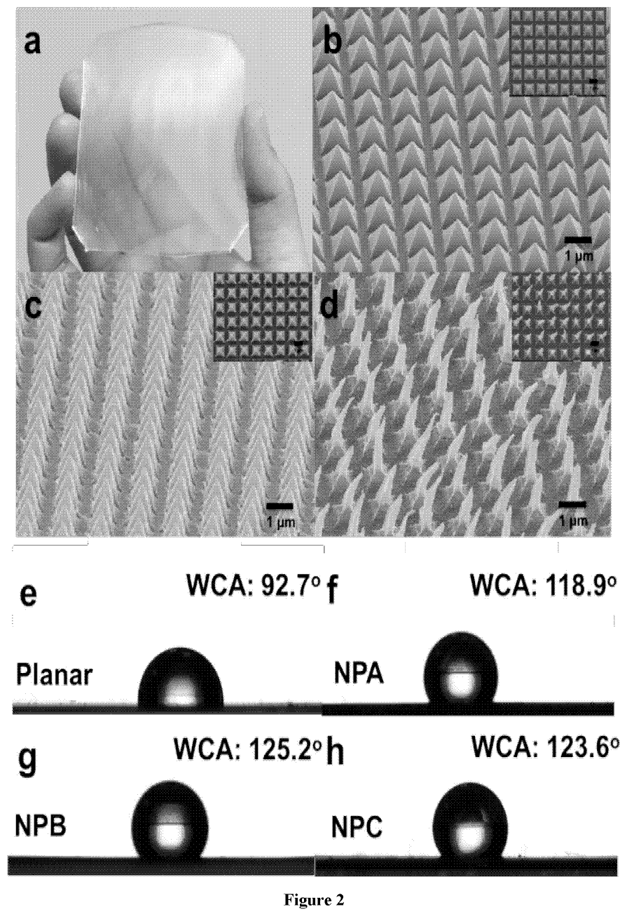

With the process described above, the nanopyramid PS films obtained have a number of the distinct features that makes them attractive as antibacterial surface. FIG. 2a shows a photo of the fabricated film with the surface nanopyramid pattern with size of 7.5 cm×7.5 cm. The rainbow color from light diffraction, indicating perfect ordering of nanostructures on the surface. Note that the current film size is much larger than the duplicates from the pelts of shed gecko skin and cicada wing. More importantly, the reproduction of surface structures was more consistent and uniform, and this makes the film more useful for practical applications. In fact, the size of the film can be readily scaled up by stitching together multiple pieces of those nanostructured Si wafers. Here any optimized structure and shape may also be transferred into a metal mold for a manufacturing process. For example, roll-to-roll hot-embossing process can be applied to produce a continuous nanostructured antibacterial film. Since the bacterial infection in the surgical site remains a critical issue, one potential application for these nanostructures is to integrate this nanopyramid film into clinical instruments, catheters and containers that can remain bacteria-free for a prolonged period. Having a physical antibiotic surface means there is no need for use of toxic disinfectants and sterility maintenance. The material cost of plastic polymers for the biomedical applications is very low.

FIGS. 2 b-d showed the SEM images of the NPA, NPB and NPC PS film. The positive nanopyramids with a pitch of 1.5 μm was highly ordered and showed poor wetting (very high contact angle) by water. The highly ordered and tunable surface structures also provide an excellent and versatile platform to investigate interactions, at a small scale, between various nanotopography-geometry combinations and bacteria. There was wide-ranging selectivity for different morphologies provided by varying thickness of Cr sputtered coating on the Si mold, which is an effective means to control the aspect ratio of the nanoscale structures. Therefore, by modulating the Cr thickness, the relief of the structures could be altered with increasing protuberance sharpness. Water contact angle is one of the key factors that determines the bacterial adhesion on a surface. Typically, a high water contact angle suggests a low surface energy. The lower the surface energy, the more difficult for bacteria adhere to the surface. Therefore, water contact angle is used to compare surfaces for their antibacterial potential.

FIGS. 2e-h showed the water contact angle of the Planar, NPA, NPB and NPC PS film, respectively. The water contact angle significantly increased from 92.7° to around 120° for those surfaces with nanopyramid structures. It can be easily understood by using Wenzel's model of wetting that the contact angle of the surface increased with the surface roughness. Nanopyramid significantly increased the surface roughness compared to the planar sample. Therefore, the surface of the nano-patterned PS film was more hydrophobic compared to the smooth planar surface.

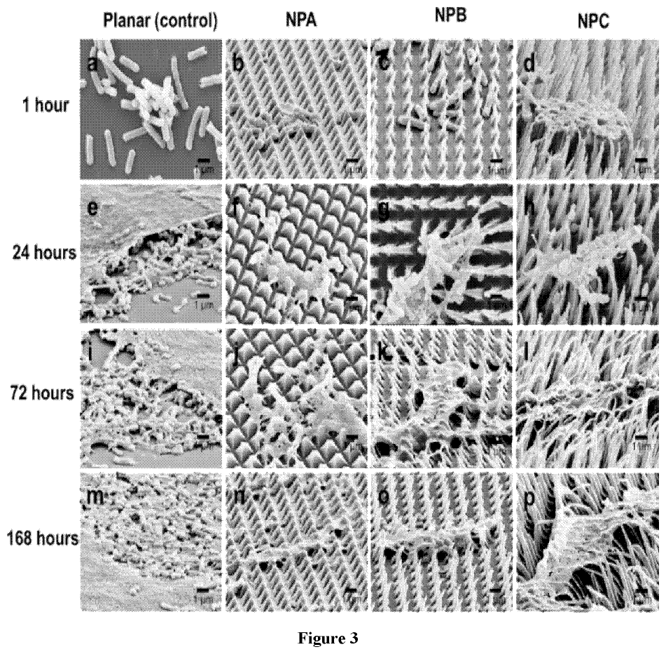

To verify the antibacterial effect of the nano-patterned surface, the three groups of molded PS films together with a smooth (non-textured control) sample were placed in an Escherichia coli (E. coli) suspension of concentration 1×109 cells/mL. Four incubation times (1 hour, 24 hours, 72 hours and 168 hours) were examined in such aqueous environment. FIG. 3 shows settling of the E. coli cells on the different surfaces of all four samples after 1, 24, 72, 168 hours of incubation time. For the control surface, the E. coli cells attached to the surface, and the amount continued to increase with time (FIGS. 3 a, e, i and m). Bacterial aggregation in a highly organised manner is one of the key phenomena indicating biofilm formation. In contrast, bacteria appeared unable to settle on nano-patterned surfaces and they were not able to congregate to any significant degree.

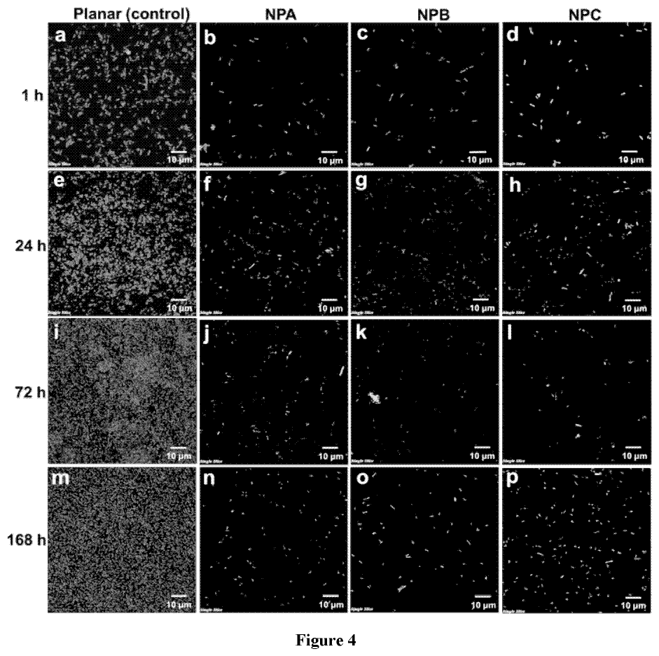

Furthermore, the regular nanostructure arrays separated individual bacterium, trapping between the protuberances, so that interaction between bacteria was significantly disturbed. For surfaces with the nanostructures with highest aspect ratio (e.g. on NPC PS film (FIG. 3 d, h, l and p)), it can be seen that bacteria were suspended on top of the nanostructure tips. The microscopic observation suggests that the nanopyramids are rigid enough, and they can prevent the bacteria cells from slipping down into the gap. However, some nano-spikes on the surface of NPC PS film were bent, with those cells that had been punctured and now situating on top of the tip. These cells formed clusters with neighboring dead cells also suspended at the tips of the adjacent nanostructures. The 24-hour incubated samples showed the presence of intact bacteria on the planar (control) surface, with de novo elements of biofilm community formation (FIGS. 3 a, e, i and m). However, the result was clearly different in the nanostructured samples. Some bacteria appeared to have been shredded by the nanostructures (FIGS. 3 b-d, f-h, k-l and n-p). The higher the aspect ratio for the nanopryamid structures, the more the bacteria cells were ruptured and deceased. After the 72-hour and 168-hour incubation, the E. coli population increased in quantity significantly in the control sample, as expected (see FIG. 4 below), resulting in biofilm formation. In contrast, the majority of bacteria on those nano-patterned surfaces were shredded and ruptured (FIGS. 3 b-d, f-h, j-l and n-p).

Confocal laser scanning microscopy (CLSM) was used to quantify the effectiveness of bacteria annhilation on the different surfaces after 1, 24, 72 and 168 hours E. coli incubation. A mixture of SYTO 9 and propidium iodide stains were used as the fluorescent dyes to visualize the live and dead E. coli cells in CLSM. Cells with intact cell membranes staining green are considered to be viable while cells with damaged membranes staining red are considered to be non-viable. For the planar (control) sample, it could be clearly seen that the density of live E. coli cells increased with time in an exponential manner, and that an overwhelming majority of them remained vital and alive. Apparently, the surface density of cells on the flat surface is significantly greater than that on the nano-patterned surfaces throughout the period of incubation, regardless of type of nanostructures, as shown in FIGS. 4 b-d, f-h, j-l and n-p. And CLSM fluorescence images also show that a significant quantity of dead bacteria can be observed. It is apparent that the growth and proliferation of E. coli is inhibited on the nanostructured surfaces.

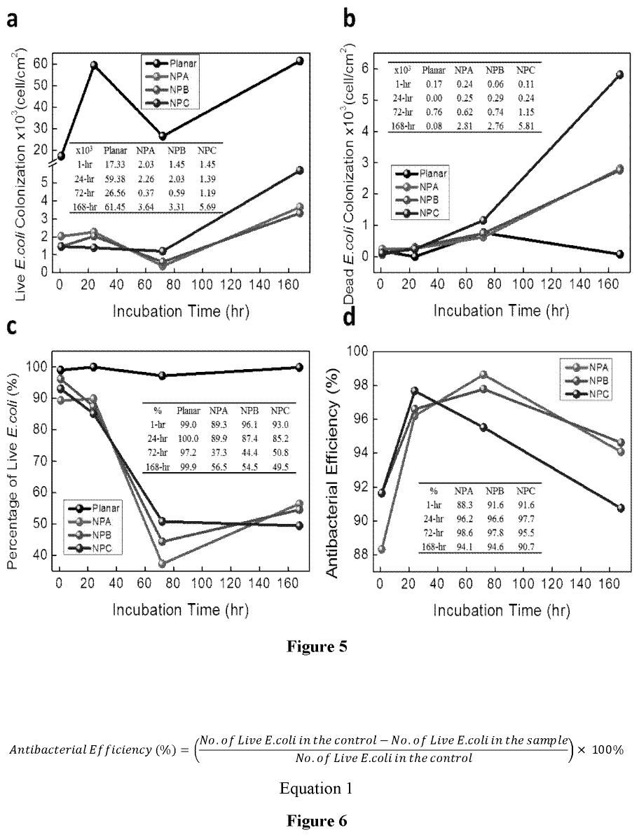

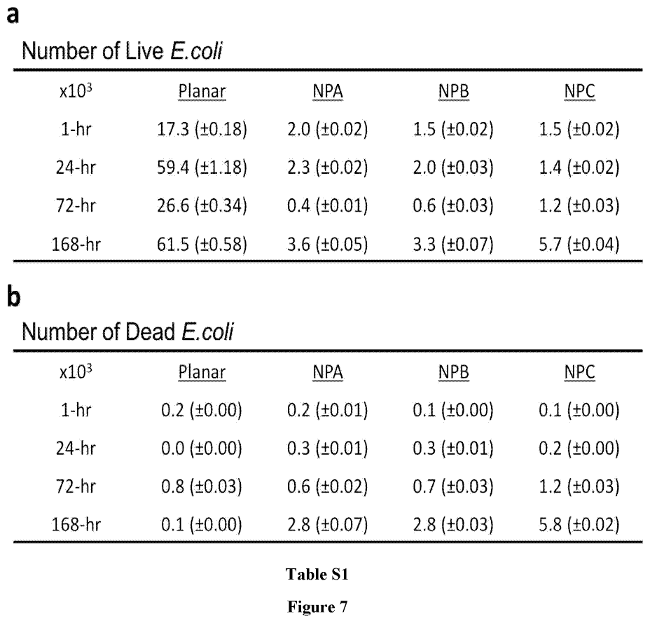

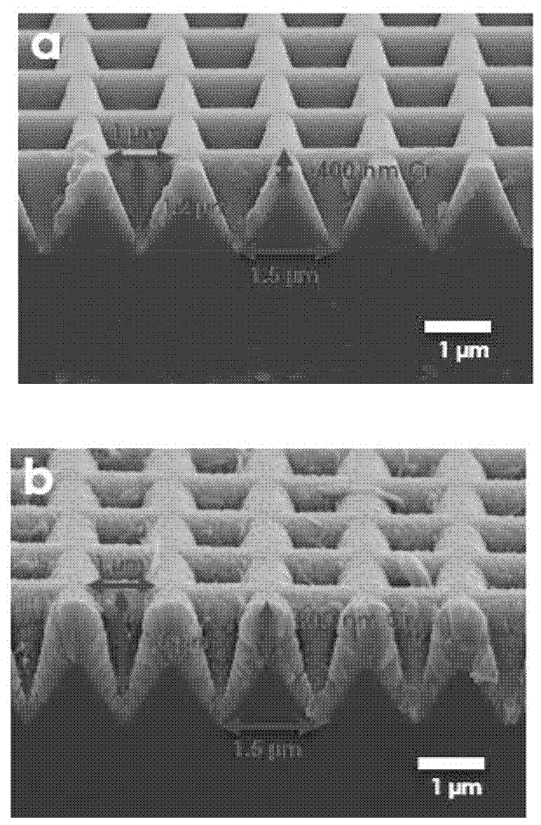

To systematically analyze the bactericidal effect on all three types of nanostructures, namely NPA, NPB and NPC, the result from the confocal laser scanning microscopy has been summarized in FIG. 5 and Table S1 of FIG. 7. FIG. 5a showed the differential colonization of live E. coli on the nanostructured surfaces. It can be seen that on the planar sample, colonization by live E. coli increased from 17.33×103 to 59.38×103 cell/cm² over 24 hours, but that then decreased to 26.56×103 cells/cm² from the 24-hr to 72-hr incubation time. This might be caused by the limit imposed by bacteria's life cycle. The amount of bacteria increased again to 61.45 cells/cm² at 168 hours, and the reason will be explained in the next paragraph.

Initially, E. coli cells adhered to the planar, smooth PS surface and then started reproduction process so that the colonization rate increased exponentially in the first 24 hours. However, the life cycle of E. coli came to an end after 24 hours and hence the amount of live E. coli decreased. Compared to the planar control, the three nanostructured samples showed excellent antibacterial performance. The colonization for live E. coli over 168 hours remained at a low level. Most of the specimens showed colonization below 4.0×103 cells/cm2. Generally speaking, the growth and attachment of live E. coli cells on the nanostructured surface was inhibited in the first 72-hour, after which the growth picked up again, but the amount remained very low compared with the control.

One explanation for the presence of some bacteria attaching onto the nanostructured surface might be that the “valleys” of the nanopatterns have been filled up and the nanostructures were flattened by some adherent dead bacteria; and some later arriving cells managed to grow on the flattened surface. Bactericidal effect was demonstrated by the nanostructured surface through the biophysical action (perforating and rupturing of the bacteria) at least in the first 72 hours. For longer periods of incubation, SEM images showed that the dead E. coli cells were plentiful within the gap of the nanostructures (FIGS. 3 j, k, l, n, o and p). The flattened area have permitted new bacteria to attach and grow. The amount of dead E. coli that remained on the various surfaces was summarized in FIG. 5b. Colonization by dead E. coli cells was low, often with less than 1.0×103 cells/cm² in the first 72-hour of incubation, but it increased steadily with time on the nanostructured surface. The accumulation rate on NPC surface is the fastest, reaching 1.15×103 cells/cm² after 72 hours and 5.81×103 cells/cm² after 168-hr incubation, while the other two nanostructured samples is only around 2.8×103 cells/cm² after 168 hrs. This observation can be explained by the biophysical bactericidal mechanism of nanopyramids. The attached E. coli was neaturalized by being punctured and ruptured by the nanostructures and the annihilation rate depends on the sharpness of the nanopyramids. The higher the aspect ratio for the nanostructures, the easier the E. coli cells are ruptured and annihilated on the surface. The NPC PS film had outstanding bactericidal effect due to its highest aspect ratio among the three types of nanostructures, thus resulting in a greater amount of dead bacterial cells collected on that surface. On the planar sample, there are the least dead E. coli, about 0.08×103 cells/cm², was found on the surface over 168-hr incubation. There was a peak in the number of dead cells at 72 hours, which is due to the natural cell cycle (death) of E. coli as mentioned before.

See FIG. 6, noting equation 1.

Besides studying the exact number of live and dead E. coli, it is also worthwhile to calculate the proportion of the live E. coli in all adhered bacteria, so that the bactericidal mechanism of adhered bacteria could be studied. FIG. 5c shows the percentage of live E. coli among all adhered bacteria. On the planar sample, over 97% of the adhered E. coli were alive within the 168 hrs incubation period. It implied that planar PS surface had almost no bactericidal effect on the adhered E. coli. However, the result was totally different on nanopyramid surfaces. All samples showed a similar trend in the 168 hrs incubation period. Most of the adhered E. coli (around 90%) remained alive in the first 1 hour and it reduced to around 85% after 24 hours and continued to decline to below 50% after 72 hours. Then, the proportion of live and dead E. coli reached equilibrium to around 50% after 168-hr incubation. It showed bactericidal rate that biophysical bactericidal effect is not initiated immediately at the moment of the E. coli attaching to the nanostructured surfaces. Then, the adhered bacteria were killed with time of adhesion. Similar phenomena were also observed in our previous studies. This trend coincided our previously proposed mechanism of the mechanical destruction of adhered cells by gradual compression force added by surrounding nanostructures. At the end, the proportion of live and dead bacteria reached equilibrium in 168-hr incubation. It is because some nanostructure areas were flattened by the dead bacteria and part of new coming bacteria grew on the planar area without being killed. An equilibrium was achieved. Finally, the antibacterial performance for different surfaces were compared. Antibacterial performance of a nanostructured surface can be considered as the combinational effect of anti-adhesion and biophysical bactericidal in this study. Both effects gave the same result of reducing the number of live E. coli on the surface so that the growth of biofilm was largely inhibited. The number of the live bacteria on the surface could be used as the figure of merit to calculate the antibacterial efficiency of nanostructured film compared to the planar sample as the control. The calculation method was shown in the Equation 1 of FIG. 6. FIG. 5d shows the antibacterial efficiency of NPA, NPB and NPC at different incubation time. Most of the conditions showed an excellent antibacterial performance of >90% efficiency to prevent live bacteria on the surface. They showed a similar trend of bell shape in the antibacterial performance. The efficiency increased initially to reach the peak and then decreased.

Specifically, NPC reaches its best antibacterial efficiency of 97.7% at 24-hr incubation and then progressively decrease to 90.7% at 168-hr incubation time. NPA and NPB showed a more similar trend that they reached the peak at 72-hr incubation to around 96% and decreased to around 94% at 168-hr incubation but NPA started with a lower efficiency of 88.3% while NPB started with 91.6%. The trend could be explained by the progressive weakening of the combined action of anti-adhesion and biophysical bactericidal effect with the incubation time. Both effects were weakened due to the flattening of nanostructures by adhered dead bacteria. The initial increase in the efficiency was mainly contributed by the biophysical bactericidal effect as mentioned previously. The bactericidal effect dramatically dropped afterwards because the nanostructures were covered to form flattened surface. The performance was expected to further decrease after 168-hr use. After all, the nanopyramid films definitely showed an excellent antibacterial performance compared to the planar surface.

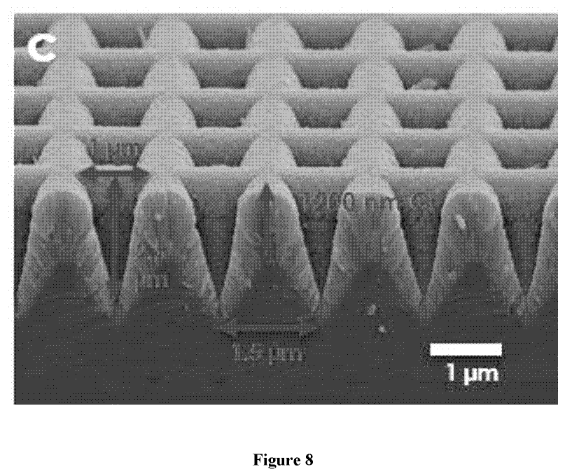

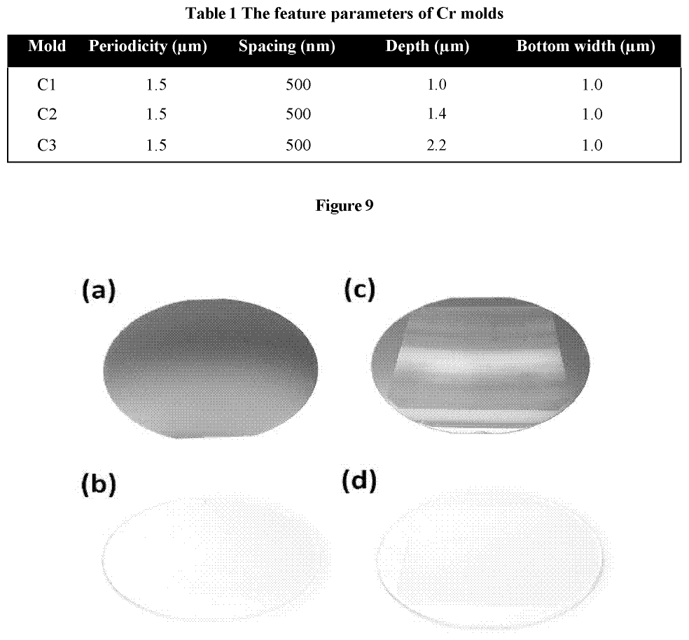

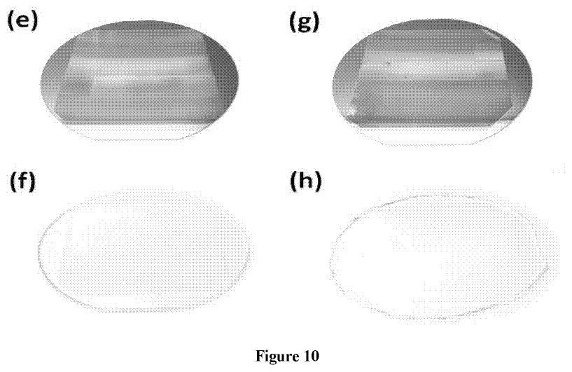

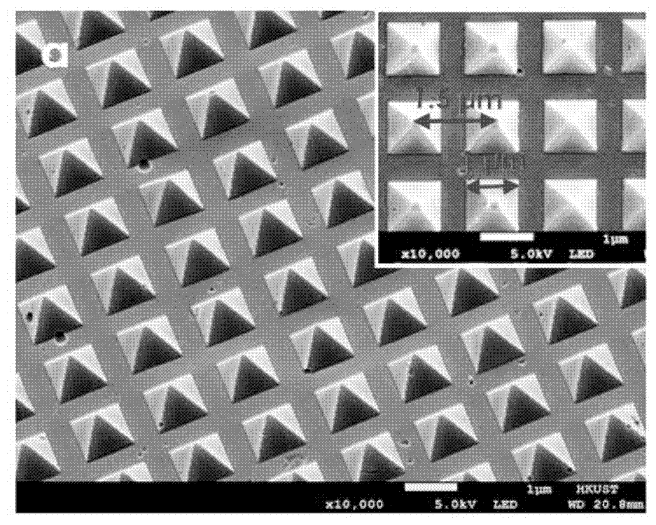

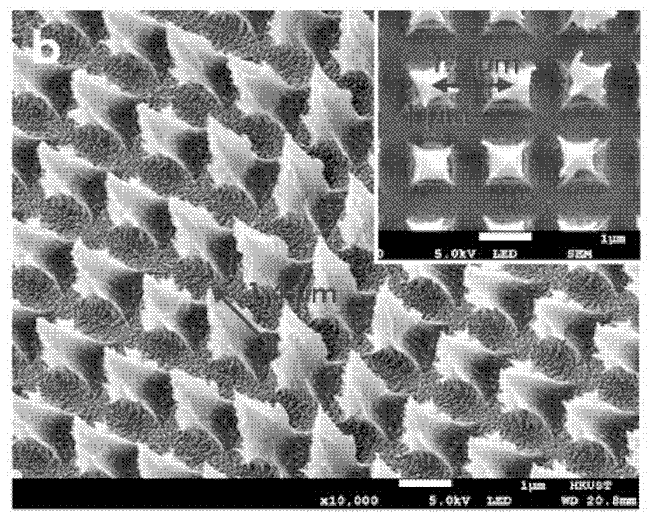

Notice that the i-pyramids became sharper with a higher aspect ratio (FIG. 9—Table 1) when a greater amount of Cr was deposited in the z-direction (FIG. 8). Finally, PMMA solution, prepared by dissolving 10 g of PMMA powder (Alfa Aesar; Thermo Fisher Scientific, Heysham, United Kingdom) in 100 mL of toluene (AR, Kemmar, RCI Labscan, Bangkok, Thailand), is poured onto the surface of the Cr-coated wafers, followed by heat curing at 90° C. for 1 h, and then 120° C. for another 30 min. The Cr happened to also serve as an anti-sticking layer such that the mold can be used many times without leaving any residues. Several groups of PMMA specimen have been prepared for characterization: 1) N1 (from Cr400 mold); 2) N2 (from Cr800 mold); 3) N3 (from Cr1200 mold); and 4) non-textured, i.e. smooth, flat PMMA (control group). Specimens with nanopatterned surface showed “rainbow” spectral banding when viewed under white light, due to the size of the nanostructure that diffracts light into various colours (FIG. 10).

FIG. 10 shows photographs of the Cr-sputtered i-pyramid molds and fabricated nano-pyramid PMMA films: (a) Flat silica wafer, (b) flat PMMA film, (c) C1 mold, (d) N1 film, (e) C2 mold, (f) N2 film, (g) C3 mold, and (h) N3 film.

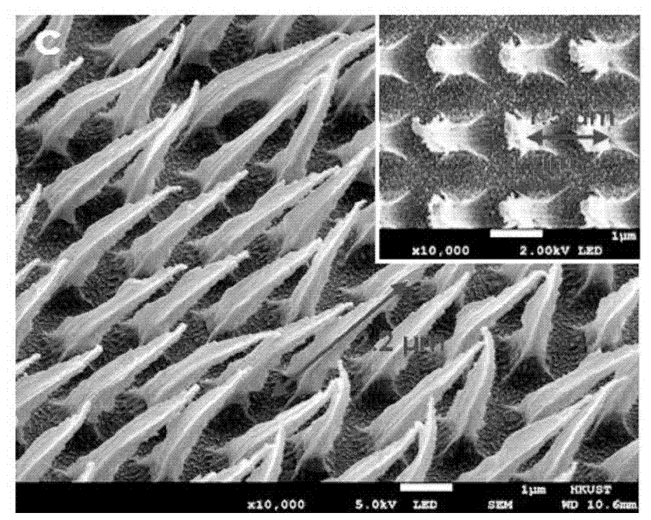

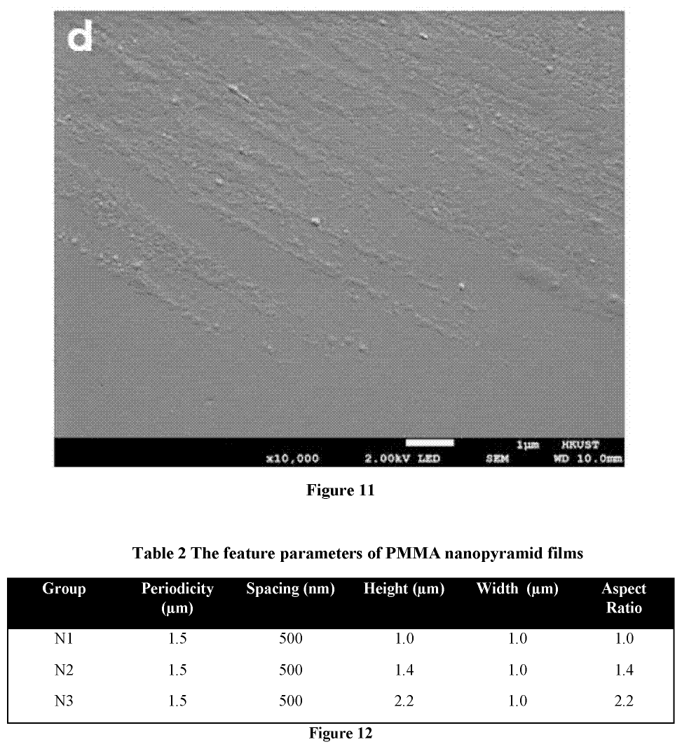

Corresponding to the features of i-pyramids for each Cr mold, the surface feature of NP400 was low-rise and pyramid-like (FIG. 11a). The spinules on N1 surface were at around 1.4 μm, and with a more definite pointed tip (FIG. 11b). The N3 group showed minute slender or spinules with pointed tips; the height of the spinules was about 2.2 μm. The measurements for the three groups of PMMA projections were summarized in FIG. 12—Table 2.

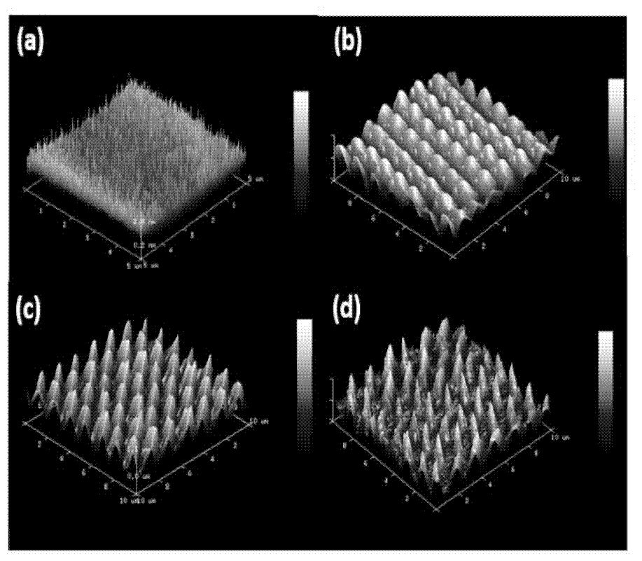

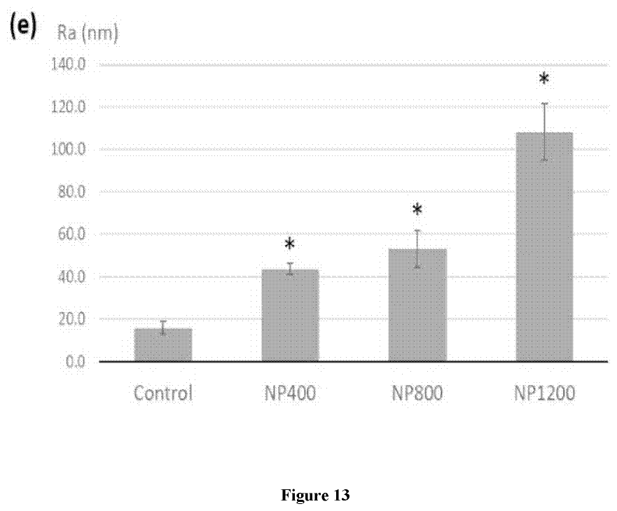

The mean Ra values of the nanoscale pyramidal surfaces ranged from 43.7±2.7 nm (for N1), 53.1±8.8 nm (for N2) to 108.0±13.4 nm (for N3), all of which were statistically different from the control (15.9±2.9 nm for the control) (FIG. 13). There were statistically significant differences between the experimental groups (p<0.05).

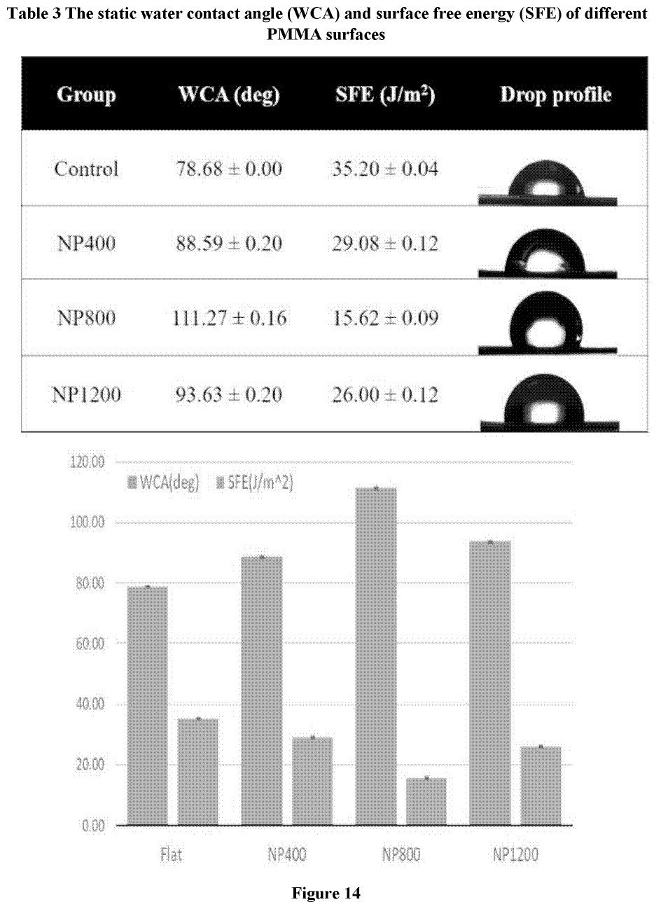

Referring to FIG. 14, the average water contact angle (WCA) significantly increased from 78.68° (for the smooth control) to around or above 90° (88.59±0.20° for N1, 111.27±0.16° for N2, 93.63±0.20° for N3) in the experimental groups. The corresponding surface free energy (SFE) decreased from 35.20±0.20 J/m² for smooth control to below 29.08±0.12 J/m² for N1, 15.62±0.09 J/m² for N2 and 26.00±0.12 J/m2 for N3.

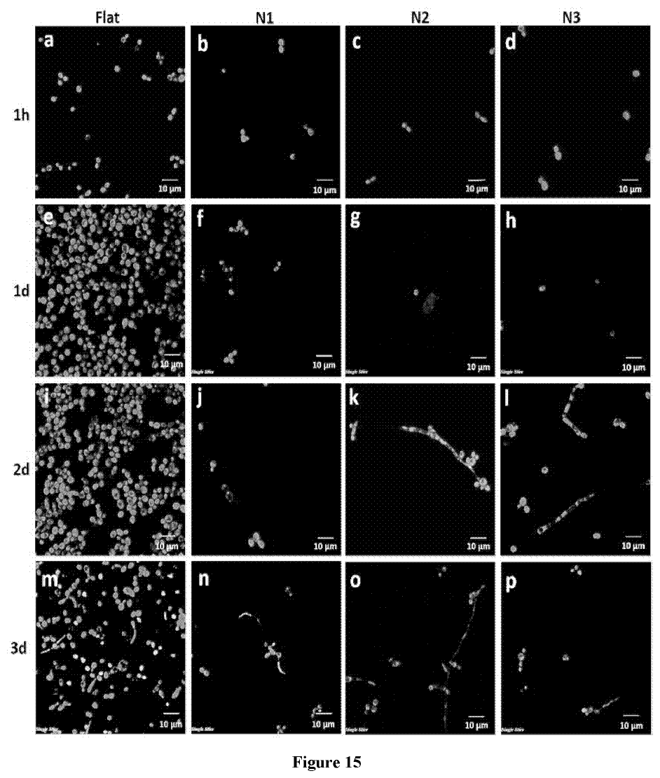

FIG. 15 shows confocal scanning laser microscopy (CLSM) images of Candida albicans biofilm grown on the different PMMA surfaces at the different incubation time period: (a-d) 1-hour incubation; (e-h) 1-day incubation; (i-l) 2 day incubation; (m-p) 3-day incubation (measurement area=126×126 μm2, image size=640×640 pixels). (Scale bar=10 μm).

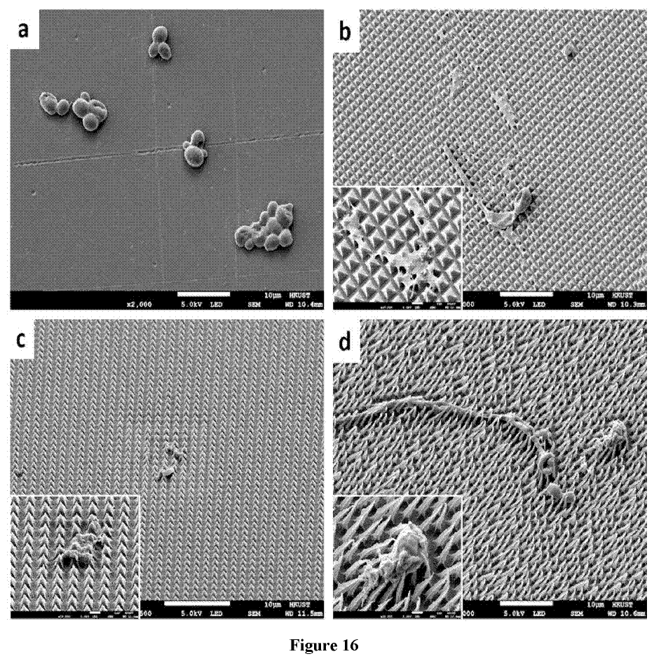

FIG. 16 shows the SEM images of C. albicans on the different PMMA surfaces at 1 hour: (a) Smooth control; (b) N1; (c) N2; and (d) N3. (Scale bar=1 μm, magnification: ×10,000).

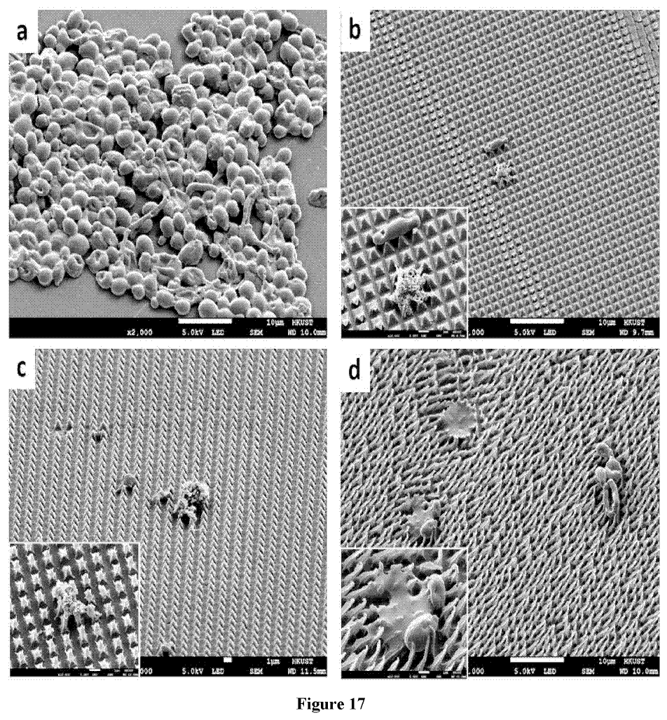

FIG. 17 shows the SEM images of C. albicans on the different PMMA surfaces at 1 day: (a) Smooth control; (b) N1; (c) N2; and (d) N3. (Scale bar=1 μm, magnification: ×10,000).

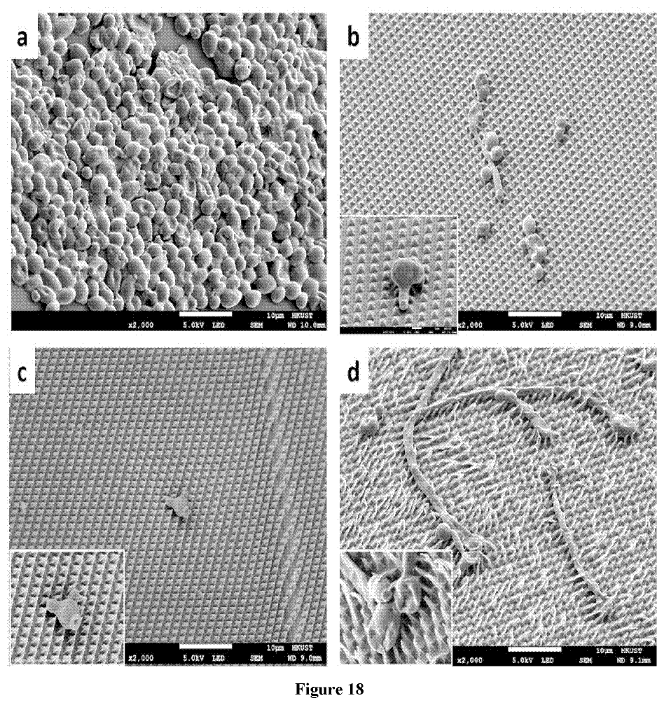

FIG. 18 shows the SEM images of C. albicans on the different PMMA surfaces at 2 days: (a) Smooth control; (b) N1; (c) N2; and (d) N3. (Scale bar=1 μm, magnification: ×10,000).

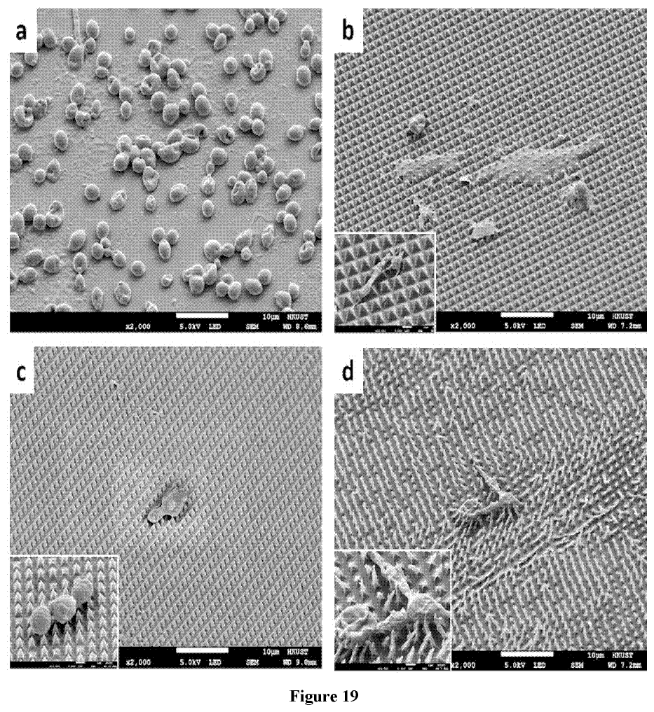

FIG. 19 shows the SEM images of C. albicans on the different PMMA surfaces at 3 days: (a) Smooth control; (b) N1; (c) N2; and (d) N3. (Scale bar=1 μm, magnification: ×10,000).

Materials:
Group A: 1 wt % ZnO in PMMA Ra˜0.3 um
Group B: 5 wt % ZnO in PMMA Ra˜0.3 um
Group C: 10 wt % ZnO in PMMA Ra˜0.3 um
Group D: NP400
Group E: NP800
Group F: NP1200
Group G: Flat Titanium (cp-2) Ra˜0.3 um
Group H: Flat PMMA (control) Ra˜0.3 um
Results: Different subscript lower case letters in the same column indicate the significant differences (p<0.05). Table: Log CFU/disk (8 mm diameter) [n=6]

| Time | | Group | S mutans | S sangunis | C albicans |
|---|---|---|---|---|---|
| 4 | h | A | 5.50 ± 0.20 b | 5.53 ± 0.02 f | 5.73 ± 0.02 j |
| | | B | 5.42 ± 0.11 b | 5.54 ± 0.08 f | 5.61 ± 0.11 j |
| | | C | 5.21 ± 0.10 b | 5.33 ± 0.02 f | 5.48 ± 0.01 j |
| | | D | 4.34 ± 0.08 c | 4.10 ± 0.11 g | 3.77 ± 0.11 k |
| | | E | 4.52 ± 0.16 c | 4.04 ± 0.12 g | 3.89 ± 0.07 k |
| | | F | 4.34 ± 0.04 c | 4.27 ± 0.02 g | 3.71 ± 0.14 k |
| | | G | 5.80 ± 0.07 a | 5.78 ± 0.12 f | 4.98 ± 0.15 l |
| | | H | 5.51 ± 0.17 a | 5.68 ± 0.02 f | 5.47 ± 0.07 j |
| 1 | day | A | 7.89 ± 0.17 d | 6.61 ± 0.11 h | 7.63 ± 0.12 m |
| | | B | 7.20 ± 0.05 d | 6.67 ± 0.31 h | 7.10 ± 0.04 m |
| | | C | 6.81 ± 0.01 e | 6.72 ± 0.20 h | 7.31 ± 0.05 m |
| | | D | 4.14 ± 0.05 c | 4.23 ± 0.02 g | 4.02 ± 0.03 k |
| | | E | 4.41 ± 0.03 c | 4.31 ± 0.04 g | 4.06 ± 0.13 k |
| | | F | 4.78 ± 0.14 c | 4.57 ± 0.12 g | 4.11 ± 0.08 k |
| | | G | 6.41 ± 0.03 e | 6.88 ± 0.04 h | 6.23 ± 0.05 n |
| | | H | 7.78 ± 0.24 d | 6.87 ± 0.11 h | 7.27 ± 0.11 m |
| 7 | day | A | 7.90 ± 0.01 d | 7.54 ± 0.03 i | 7.88 ± 0.03 o |
| | | B | 7.38 ± 0.10 d | 7.42 ± 0.04 i | 7.36 ± 0.11 m |
| | | C | 7.64 ± 0.11 d | 7.35 ± 0.02 i | 7.15 ± 0.02 m |
| | | D | 4.40 ± 0.04 c | 4.41 ± 0.08 g | 4.14 ± 0.02 k |
| | | E | 4.53 ± 0.02 c | 4.10 ± 0.03 g | 4.18 ± 0.08 k |
| | | F | 4.71 ± 0.03 c | 4.13 ± 0.20 g | 4.23 ± 0.11 k |
| | | G | 7.11 ± 0.13 d | 7.02 ± 0.10 i | 6.44 ± 0.07 n |
| | | H | 7.89 ± 0.20 d | 7.01 ± 0.13 i | 7.71 ± 0.03 o |

In summary, described herein is a facile process to fabricate large-scale, flexible nanostructured films with regular nano-engineered templates. It has been proved that these films possess antibacterial effect and can inhibit the growth of biofilm on their surfaces. The antibacterial mechanism and performance were quantitatively examined by SEM and CLSM analysis. These nanostructured surfaces showed excellent and effective bactericidal performance with >90% reduction of E. coli colonization on the surface, compared with the control flat sample. Moreover, that effectiveness can be maintained up to 168 hours without cleaning. The reported nano-patterned films can be applied in clinical applications to reduce the risk of pathogenic infection.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A dental appliance having antimicrobial properties, the dental device comprising nanostructures on at least a portion of a surface thereof, the nanostructures having a pyramid-like shape with a periodicity from to 0.25 μm to 5 μm, a height from 0.25 μm to 5 μm, and an aspect ratio from 0.5 to 5.

2. The dental appliance according to claim 1, wherein the antimicrobial properties include anti-fungal properties and antibacterial properties.

3. The dental appliance according to claim 1, wherein the antimicrobial properties exist with the proviso that a chemical agent is not required.

4. A method of inhibiting the formation of a biofilm a medical device, comprising:
applying nanostructures on at least a portion of a surface of the medical device, the nanostructures having a pyramid-like shape with a periodicity from to 0.25 μm to 5 μm, a height from 0.25 μm to 5 μm, and an aspect ratio from 0.5 to 5.

5. The method according to claim 4, wherein the medical device is a dental appliance.
